(19) United States
(12) Patent Application Publication
(10) Pub. No.: US 2026/0357108 A1
(43) Pub. Date: Nov. 12, 2026

(54) ADHESION PROMOTER FOR POLYSULFIDE- AND POLYTHIOETHER-BASED SEALANTS

(71) Applicant: CHEMETALL GMBH, Frankfurt (DE)

(72) Inventor: Nadine NEUSCHAEFER, Ludwigshafen (DE)

(21) Appl. No.: 19/486,206

(22) PCT Filed: Jun. 14, 2024
(86) PCT No.: PCT/EP2024/066584

§ 371 Date: Nov. 20, 2025

(30) Foreign Application Priority Data
Jun. 16, 2023 (EP) 23179829.9

(51) Int. Cl. C09D 183/08; C09D 7/20; C09D 181/04

(52) U.S. Cl. CPC C09D 183/08; C09D 7/20; C09D 181/04

(57) ABSTRACT

Described herein is a method of sealing a substrate including at least steps 1) and 3), namely applying a solventborne composition at least in portion onto a surface of a substrate to form a film at least in portion on the surface (1)), applying a sealant composition at least in portion onto the film obtained after step 1) to form a sealant film (3)), where the sealant composition is obtainable by mixing at least components A) and B) of a sealing system, where the solventborne composition applied in step 1) includes at least two different alcohols as organic solvents as constituent a1), at least one organic metalate as constituent a2), and at least one organosilane as constituent a3). Also described herein are a sealed substrate obtainable by the method, a use of the solventborne composition as adhesion promoting composition, the solventborne composition, and a kit-of-parts including the solventborne composition.

The present invention relates to a method of sealing an optionally pre-coated substrate, which includes application of a solventborne composition as adhesion promoting composition to the surface of the substrate and subsequent application of a sealant composition, a sealed substrate obtainable by this method, a use of the aforementioned solventborne composition as adhesion promoter, said solventborne composition as such, and to a kit-of-parts comprising the solventborne composition.

### BACKGROUND OF THE INVENTION

Sealants are used for a wide range of applications. They are, e.g., relevant to the aerospace sector, but are also widely used in the automotive sector. Sealants are further used for sealing construction elements, connection of metal sheets, for example, to existing structures, such as segments of an airplane and/or for corrosion protection in places, where for example, in the region of holes, the corrosion protection layers of the metallic elements are damaged or removed. They may also exert a temporary carrying function, for example during transportation of structures to be mounted, which have to be subsequently provided with permanent supporting connection elements.

It is necessary that the sealants are sufficiently adhered to the surfaces of the substrates. A use of a variety of different adhesion promoters for various substrates is known in the prior art for this purpose, i.e., in order to provide adhesion of the substrate to the sealant applied on top.

It is possible to directly incorporate suitable adhesion promoters into sealant compositions used to form sealant for this purpose. It is also possible to apply adhesion promoters onto the surfaces of the substrates to be sealed prior to application of the sealant externally in a separate step. Such types of adhesion promoters are known from US 2021/0402748 A1 and US 2021/0187922 A1: Reference US 2021/0402748 A1 relates to adhesion promoting compositions for enhancing adhesion between adjoining layers of sulfur-containing sealants, which comprise a free radical polymerizable compound such as functional (meth)acrylate oligomers, a free radical initiator; and a volatile organic solvent. US 2021/0187922 A1 discloses a multilayer sealant comprising a first sulfur-containing sealant layer, an adhesion-promoting interlayer overlying the first sulfur-containing sealant layer and a second sulfur-containing sealant layer overlying the adhesion-promoting interlayer, wherein the adhesion-promoting interlayer comprises a crosslinked free radical polymerized compound.

Further types of such adhesion promoters, which make use of compositions comprising metal alkoxides, are disclosed in US 2021/0047488 A1 and US 2021/002514 A1. Reference US 2021/0047488 A1 relates to a method and a composition for preparing a surface comprising a thermoplastic or thermoset material such as polyamide materials to receive a polysulfide or polythioether sealant or coating, the method comprising applying to the surface an activating composition consisting of a tetraalkoxide of a Group 4 metal and/or a complex of an alkoxide of a Group 4 metal. US 2021/002514 A1 relates to a composition for surface activation, which comprises an organic solvent and a transition metal alkoxide and optionally water. A sealant layer can be applied on top of the dried layer obtained from application of the composition.

Silanes, in particular organosilanes, are also known to be suitable as adhesion promoters for various substrates. Due to their vast compatibility to many chemical systems, they can be used in various different materials including sealant materials, but also in separately to be applied adhesion promoting compositions. Compared to other chemically different adhesion promoters like, e.g., phenolic resins or polyolefins, silanes usually do not significantly influence the pH environment within the material they are utilized in, which becomes especially important for applications, where ambient conditions such as a constant pH environment are critical for the curing properties of the material, which is, e.g., the case for polysulfide and/or polythioether based sealants. The use of silanes is, e.g., known from US 2021/0189206 A1 and WO 2020/232462 A1. Reference US 2021/0189206 A1 relates to adhesion promoting compositions containing organic titanates and/or zirconates, organic solvents, and an amine- and an alkenyl-functional alkoxysilane for enhancing adhesion between metal substrates and an overlying sealant such as a radical polymerized sealant, in particular based on thiol-ene chemistry, wherein the alkenyl groups of the alkenyl-functional alkoxysilanes can attach to the polymer structure of the sealant. The use of silane-based sealers is also, e.g., described in WO 2020/232462 A1, which is directed to composite structures comprising a thermoplastic substrate comprising in turn a chemical sealant direct bonded to a surface thereof, the chemical sealant providing a surface suitable for adhering adhesives, paints, and/or surfacing films to the thermoplastic surfaces.

However, the adhesion promoters known in the prior art such as disclosed in US 2021/0189206 A1 not always provide sufficient adhesion for efficiently adhering sealants onto the surfaces of the substrates to be sealed, in particular in the field of sealants for the aircraft industry and more specifically with regard to making use of sealant compositions comprising polymers with thiol groups such as polysulfide and/or polythioether based sealant compositions, in particular not for a variety of different substrates. In particular, a sufficient adhesion is not always achieved when thermoplastic or glass substrates such as polycarbonate or, e.g., PMMA (polymethyl methacrylate) substrates are used. Further, the aforementioned adhesion promoters known in the prior art often contain substantial amounts of toxic materials, which is ecologically and also economically disadvantageous. In addition, the aforementioned adhesion promoters known in the prior art such as the ones disclosed in US 2021/0189206 A1 require a comparably high content of active ingredients, in particular of the at least two kinds of silanes present therein, and, further are applied in comparably high dry layer thicknesses of several micrometers, which is disadvantageous both for ecological and economic reasons.

Thus, there is a demand for adhesion promoting compositions and for a method of sealing of substrates making use thereof, which do not exhibit the aforementioned disadvantages, in particular, when the substrates are substrates used in the aircraft industry such as optionally coated metal substrates. In particular, there is a demand for respective adhesion promoting compositions, which provide excellent adhesion between a variety of different substrates, in particular metal substrates, and sealants applied to its surfaces, wherein the sealants are obtainable from sealant compositions comprising polymers with thiol groups such as polysulfide and/or polythioethers, where the adhesion promoting compositions further can be provided in an ecologically and economically advantageous form, in particular in a non-toxic or at least low toxic form with reduced active ingredients concentration, and can be applied in low dry layer thicknesses, but without imparting their adhesion inducing properties, in particular compared to adhesion promoting compositions of the prior art.

### Problem

It has been therefore an objective underlying the present invention to provide adhesion promoting compositions and a method of sealing of substrates making use of such compositions, in particular, when the substrates are substrates used in the aircraft industry such as optionally coated metal substrates. It has been a particular objective underlying the present invention to provide adhesion promoting compositions, which is provide excellent adhesion between a variety of different substrates, such as metal substrates, and sealants applied to their surfaces, which are obtainable from sealant compositions comprising polymers with thiol groups such as polysulfide and/or polythioethers, where the adhesion promoting compositions further can be provided in an ecologically and economically advantageous form, in particular in a non-toxic or at least low toxic form with reduced active ingredients concentration, and can be applied in low dry layer thicknesses, but without imparting their adhesion inducing properties, in particular compared to adhesion promoting compositions of the prior art.

### Solution

This objective has been solved by the subject-matter of the claims of the present application as well as by the preferred embodiments thereof disclosed in this specification, i.e., by the subject matter described herein.

A first subject-matter of the present invention is a method of sealing an optionally pre-coated substrate comprising at least steps 1) and 3) and optionally at least one of steps 2) and/or 4), namely
1) applying a solventborne composition at least in portion onto a surface of an optionally pre-coated substrate to form a film at least in portion on said surface,
2) optionally drying and/or curing the film obtained after step 1),
3) applying a sealant composition, which is different from the solventborne composition used in step 1), at least in portion onto the optionally dried and/or cured film obtained after step 1) or 2) to form a sealant film, wherein the sealant composition is obtainable by mixing at least two separately present components A) and B) of a sealing system with each other, wherein component A) of the sealing system comprises at least one polymeric constituent A1) containing two or more thiol groups, which is selected from polyether, polythioether, polysulfide, polythioether-sulfide constituents and mixtures thereof, and wherein component B) of the sealing system comprises at least one constituent B0), which is suitable for curing the sealant composition by at least partially inducing a chemical transformation of the two or more thiol groups of constituent A1), and
4) optionally curing the sealant film obtained after step 3),

wherein the solventborne composition applied in step 1) comprises at least constituents a1) to a3), which are different from one another, namely
at least two organic solvents as constituent a1) in an amount of at least 85.0 wt.-%, based on the total weight of the composition, wherein said at least two organic solvents are alcohols and different from one another, and wherein at least one of the at least two alcohols has precisely one OH-group and the at least one other alcohol has at least two or more OH-groups,
at least one organic metalate as constituent a2), the metal of the metalate being selected from Ti and Zr, and
at least one organosilane as constituent a3) in an amount of at most 10.0 wt.-%, based on the total weight of the composition, wherein the sum of all constituents being present in the solventborne composition adds up to 100 wt.-%.

A further subject-matter of the present invention is a sealed substrate, obtainable by the inventive method, which is preferably suitable for use in the aircraft and/or aerospace industry.

A further subject-matter of the present invention is a use of the solventborne composition as used and defined in step 1) of the aforementioned method as adhesion promoting composition, in particular for enhancing adhesion between the surface of an optionally pre-coated substrate and a subsequently applied sealant film.

A further subject-matter of the present invention is a solventborne composition as defined in connection with step 1) of the aforementioned method per se.

A further subject-matter of the present invention is a kit-of-parts comprising separated from one another at least a sealing system as defined in connection with step 3) of the aforementioned method comprising at least two components A) and B) being separate from each other, and a solventborne composition as defined in connection with step 1) of the aforementioned method or an inventive solventborne composition.

It has been in particular surprisingly found that the solventborne compositions disclosed hereinbefore and hereinafter can be used as adhesion promoting compositions, in particular as one-component (1K) compositions, and provide excellent adhesion between a variety of different substrates usable in the aircraft and/or aerospace industry, including in particular metal substrates, and sealants applied to their surfaces, which are obtainable from sealant compositions comprising polymers with thiol groups such as polysulfide and/or polythioethers, which in particular can be cured making use epoxy resins—particularly when polythioether-based sealant compositions are used—and/or metal oxides such as manganese dioxide—particularly when polysulfide-based sealant compositions are used. The solventborne compositions can hence be applied externally on various substrates as adhesion promoters prior to any sealant application and can, e.g., be used for the assembly of aerospace and aircraft windows.

Further, it has been in particular surprisingly found that the solventborne compositions disclosed hereinbefore and hereinafter can be provided in an ecologically and economically advantageous form, in particular in a non-toxic form or in a form with a low, i.e., at least reduced, toxicity, compared to adhesion promoting compositions of the prior art, without imparting their adhesion inducing properties. In particular, it has been found that the solventborne compositions disclosed hereinbefore and hereinafter exhibit flashpoints of >40 °C and thus have no or only a very low hazard potential, in particular compared to solventborne compositions of the prior art. It has been found that the achieved sufficiently high flashpoints are a result of the presence of constituent a1) the solventborne compositions according to the present invention.

Moreover, it has been in particular surprisingly found that the solventborne compositions disclosed hereinbefore and hereinafter can be provided and used in a form having a lower active ingredient content, in particular as far as constituents a2) and/or a3) are concerned, when compared to conventional adhesion promoters known in the prior art. As far as the at least one organosilane as constituent a3) is concerned, it has been in particular found that when the amount of a3) is too high, in particular when the amount exceeds 10.0 wt.-%, based on the total weight of the composition, adhesive failure may be observed after having applied the solventborne composition in step 1).

In addition, it has been surprisingly found that the solventborne compositions disclosed hereinbefore and hereinafter can be applied in very thin layers only, e.g., in dry layer thicknesses being substantially lower than 1 μm such as in dry layer thicknesses of 300 nm or 200 nm or lower. This has the particular advantage that a comparably low active ingredient concentration, in particular with respect to constituents a2) and a3), can be used in the solventborne compositions, but nonetheless that an excellent cohesive connection between the substrate and the sealant can be provided.

### DETAILED DESCRIPTION OF THE INVENTION

The term “comprising” in the sense of the present invention, in connection for example with the adhesion promoting composition, preferably has the meaning of “consisting of”. With regard, e.g., to the adhesion promoting composition it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in the adhesion promoting composition, add up to 100 wt.-%, based in each case on the total weight of the adhesion promoting composition.

The same applies to any other compositions disclosed herein such as sealant compositions.

### Method of Sealing an Optionally Pre-Coated Substrate

A first subject-matter of the present invention is a method of sealing an optionally pre-coated substrate comprising at least steps 1) and 3) and optionally at least one of steps 2) and/or 4). The method may optionally comprise one or more further steps, which are performed prior to any of the aforementioned steps, in between any of these steps, and/or after any of the aforementioned steps.

### Optional Cleaning Step

Optionally, and preferably, the surface of the optionally pre-coated substrate is cleaned prior to performance of step 1). Cleaning may be performed by any conventional techniques such as dipping, wiping, brushing and/or spraying. Preferably, cleaning is performed by making use of one or more organic solvents, which are applied onto the surface of the substate. An appropriate solvent can be selected, e.g., according to the recommendations of the substrate manufacturer of the particular substrate to be used. Any dirt, grease, oil and/or dust is preferably removed from the substrate surface by the cleaning step.

### Step 1)

In step 1) a solventborne composition is applied at least in portion onto a surface of an optionally pre-coated substrate to form a film at least in portion on said surface. Any kind of contacting may in general be used for application of the solventborne composition in step 1) such as dipping, wiping, brushing and/or spraying, in particular by wiping and/or brushing.

Preferably, the solventborne composition is applied in a very thin layer on the surface of the substrate. In particular, it is applied such that a dry layer thicknesses below 1.0 μm, more preferably below 900 or below 800 nm, even more preferably below 700 nm or below 600 nm, still more preferably below 500 nm or below 400 nm, most preferably below 300 or 200 nm, results, preferably after performance of optional step 2).

Preferably, the solventborne composition is applied in step 1) by wiping in a so-called “wipe-on method”. Preferably, use is made in this regard of brush, soft lint-free wipes, or pens with a felt for application of the solventborne composition. The solventborne composition is then wiped onto the surface of the substrate.

Alternatively, the solventborne composition is applied in step 1) by wiping in a so-called “wipe-on/wipe-off method”. Here, the solventborne composition is applied in excess onto the surface of the substrate. Preferably, use is made in this regard of brush, soft lint-free wipes, or pens with a felt for application of the solventborne composition. The solventborne composition is then wiped onto the surface of the substrate. Within a few seconds or minutes after the application such as 5 seconds to 10 minutes, the excess is preferably wiped off with a soft lint-free wipe in order to allow the adhesion promoting agents present in the composition such as constituents a2) and/or a3) to, e.g., undergo hydrolysis reactions.

Step 1) is preferably performed at a temperature in a range of from 0 to 60 °C, more preferably of from 5 to 45 °C. In particular, no heating is performed.

### Substrates

An optionally pre-coated substrate is used in step 1). Suitable substrates are metallic substrates (metal substrates), but also plastic substrates such as thermoplastic substrates, fiber-based composites (also named herein fiber reinforced composites) and glass substrates can be used. Preferred substrates are generally substrates utilizable in the aerospace and/or aircraft industry, e.g., as component and/or workpiece. Most preferred are metal substrates.

Suitable as metallic substrates used in accordance with the invention are all substrates used customarily and known to the skilled person. The metallic substrates used in accordance with the invention are preferably metallic substrates including substrates being composed of steel, steel alloys, aluminum, aluminum alloys, titanium and/or titanium alloys. Most preferred metallic substrates are aluminum and/or aluminum alloy substrates as well as steel and/or steel alloy substrates.

Preferably, thermoplasts are used in case the substrates are plastic substrates. Suitable thermoplastic polymers are polyalkyl(meth)acrylates including polymethyl(meth)acrylates (PMMA), polybutyl(meth)acrylates, polyethylene terephthalates, polybutylene terephthalates, polyvinylidene fluorides, polyvinyl chlorides, polyesters, including polycarbonates (PC) and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and polyalkyl(meth)acrylates including polymethyl(meth)acrylates (PMMA) are especially preferred plastic substrates.

As mentioned hereinbefore, fiber-based composites such as carbon fiber composites may also be used as substrates as well as glass substrates, in particular for windshield applications.

Preferably, the optionally pre-coated substrate is selected form metal substrates, wherein the metal is preferably selected from steel, steel alloys, aluminum, aluminum alloys, titanium, titanium alloys, and mixtures thereof, or is selected from glass substrates, thermoplastic substrates including polycarbonate and polyalkyl(meth)acrylic substrates, and fiber reinforced composite substrates, wherein the substrate in each case optionally bears at least one coating layer.

Examples of coating layers already present on the substrate, making it hence a pre-coated substrate, are primer layers or topcoat layers, which are obtainable from water-based (aqueous) or solvent-based (solventborne) primers or top coats, e.g., based on polyurethanes or epoxide resins. The coating layers if present are preferably already cured.

The substrates may have any form, shape and geometry, and can be, e.g., sheets, foils, plates etc.

### Solventborne Composition Used in Step 1)

The solventborne composition applied in step 1) of the method comprises at least constituents a1) to a3), which are different from one another, namely
at least one organic solvent as constituent a1) in an amount of at least 85.0 wt.-%, based on the total weight of the composition,
at least one organic metalate, as constituent a2), the metal of the metalate being selected from Ti and Zr, and
at least one organosilane as constituent a3) in an amount of at most 10.0 wt.-%, based on the total weight of the composition,
wherein the sum of all constituents being present in the solventborne composition adds up to 100 wt.-%.

Preferably, the solventborne composition is a one-component (1K) composition. The solventborne composition is suitable as an adhesion promoter, i.e., as an adhesion promoting composition. Preferably, the solventborne composition does not represent a sealant composition. In particular, it is different from the sealant composition applied in step 3).

The composition used in step 1) is a solventborne, i.e., organic solvent(s)-based (non-aqueous) composition. The term “solventborne” is understood preferably for the purposes of the present invention in this regard to mean that organic solvent(s) (as constituent a1) is/are present as the main constituent of all solvents present in the composition including water. All conventional organic solvents known to those skilled in the art can be used as organic solvents. The term “organic solvent” is known to those skilled in the art, in particular from Council Directive 1999/13/EC of 11 Mar. 1999.

The solventborne composition preferably is free or essentially free of water or alternatively may comprise low amounts of water. The term “essentially” in this context preferably means that no water is added on purpose when preparing the composition. The term “low amount” in this context preferably means that water may be present in up to 12.5 wt.-% or up to 10 wt.-% or up to 5 wt.-%, based on the total weight of the composition, in particular in case it is desired to achieve some level of pre-hydrolyzation of, e.g., the organosilane constituent a3) and/or the constituent a2). In particular, in case a constituent a2) is used, which strongly reacts with water such that an immediate hydrolysis to TiO₂ or ZrO₂ takes place, the presence of water is not desired.

### Constituent a1) of the Solventborne Composition

Constituent a1) is at least one organic solvent, which is present in an amount of at least 85.0 wt.-%, based on the total weight of the composition. The solventborne composition may comprise more than one organic solvent as constituent a1) and preferably does. Hence, preferably, the solventborne composition comprises at least two or three organic solvents as constituent a1), which are different from one another. The composition may even comprise more than three such as four different organic solvents. However, preferably, the maximum number of different organic solvents present therein is four.

Preferably, the solventborne composition used in step 1) comprises the at least one organic solvent as constituent a1) in an amount in a range of from 85.0 wt.-% to 99.0 wt.-%, more preferably of from 85.0 wt.-% to 98.5 wt.-%, even more preferably of from 85.0 wt.-% to 98.0 wt.-%, still more preferably of from 87.5 to 97.5 wt.-%, yet more preferably of from 90.0 to 97.5 wt.-%, even more preferably of from 92.5 to 97.5 wt.-%, most preferably of from 95.0 to 97.0 wt.-%, in each case based on the total weight of the composition.

Preferably, in particular when the optionally coated substrate used in step 1) is a metal substrate, the solventborne composition used in step 1) comprises the at least one organic solvent as constituent a1) in an amount in a range of from 87.5 wt.-% to 99.0 wt.-%, more preferably of from 90.0 wt.-% to 98.0 wt.-%, even more preferably of from 92.5 wt.-% to 97.5 wt.-%, still more preferably of from 94.0 to 97.0 wt.-%, in each case based on the total weight of the composition.

Suitable organic solvents for use as constituent a1) are alcohols, preferably monomeric alcohols, including alcohols having more than OH-group such as diols with two OH-groups, and polyols with more than two OH-groups, ethers, esters, ketones, hydrocarbons such as aliphatic preferably branched hydrocarbons, preferably having to 20 carbon atoms, and mixtures thereof. Examples of alcohols are 1-ethoxypropan-2-ol, 2-methylpentane-2,4-diol, ethanol, isopropanol, and isobutanol. An example of a suitable ketone is 5-methyl-2-hexan-2-one. Example of suitable esters are ethyl acetate and butyl acetate. Examples of aliphatic preferably branched hydrocarbons are isoalkanes. Such aliphatic hydrocarbons are commercially available, e.g., as Isopar® C, Isopar® E, Isopar® G, and Isopar® H (available from ExxonMobil). Most preferred is Isopar® G.

Very particularly suitable organic solvents for use as constituent a1) in the solventborne composition used in step 1) are alcohols, ethers, ketones, and mixtures thereof, most preferably alcohols, when the optionally coated substrate used in step 1) is a metal substrate. Most preferred are alcohols such as a mixture of at least two alcohols, in particular at least one alcohol having precisely one OH-group such as 1-ethoxypropan-2-ol, and at least one alcohol having precisely two or more OH-groups such as 2-methylpentane-2,4-diol, wherein preferably the at least one alcohol having precisely one OH-group is used in excess compared to the at least one alcohol having two or more OH-groups, wherein more preferably the relative weight ratio of the at least one alcohol having precisely one OH-group to the at least one alcohol having two or more OH-groups is in a range of from 5:1 to 3:1. Such organic solvents are non-toxic or have an only low toxicity. Further, the use of such organic solvents is advantageous in term of a good balance between the flashpoint, which preferably is >40 °C, and evaporation speed of the organic solvents. If the evaporation speed is too slow, then there may be delays in the production process. Preferably, each of the organic solvents for use as constituent a1) in the solventborne composition used in step 1), in particular when the optionally coated substrate used in step 1) is a metal substrate, has 3 to 10 carbon atoms, preferably 4 to 8 or 4 to 7 carbon atoms, and optionally bears one or more ether functions. The presence of ether functions is particularly advantageous for achieving a sufficient solubility of constituent a2) and/or a3) and/or optional constituent a4) in the solventborne composition.

Preferably, the solventborne composition used in step 1) comprises at least two organic solvents as constituent a1), which are different from one another, preferably wherein at least one of these at least two organic solvents is an alcohol having one or more OH-groups, which further optionally bears at least one ether segment, preferably a monomeric alcohol having one or more OH-groups, preferably a monomeric alcohol having precisely one OH-group.

Preferably, the solventborne composition used in step 1) comprises at least two organic solvents as constituent a1), which are different from each other, namely at least two alcohols, each having one or more OH-groups and each having preferably 3 to 10 or 4 to 7 carbon atoms, which preferably are monomeric alcohols, wherein preferably one of the at least two alcohols has precisely one OH-group and optionally bears at least one ether segment, and at least one other alcohol has at least two or more OH-groups, hence being a diol (in case of two OH-groups) or being a polyol (in case of more than two OH-groups), wherein preferably the amount of the at least one alcohol having precisely one OH-group in wt.-% exceeds the amount of the at least one other alcohol having at least two OH-groups in wt.-%, wherein more preferably the relative weight ratio of the at least one alcohol having precisely one OH-groups to the at least one alcohol having two or more OH-groups is in a range of from 5:1 to 3:1, wherein the least two alcohols are in particular present in the solventborne composition, when the optionally coated substrate used in step 1) is a metal substrate.

### Constituent a2) of the Solventborne Composition

Constituent a2) is at least one organic metalate as constituent a2), the metal of the metalate being selected from Ti and Zr. Hence, the metalate corresponds to titanates and zirconates.

Preferably, the solventborne composition used in step 1) comprises constituent a2) in an amount of at least 0.5 wt.-%, more preferably of at least 0.75 wt.-%, even more preferably of at least 1.0 wt.-%. Preferably, the solventborne composition used in step 1) comprises constituent a2) in an amount of at most 10.0 wt.-%, more preferably of at most 7.5 wt.-%, even more preferably of at most 5.0 wt.-%. Preferably, the solventborne composition used in step 1) comprises constituent a2) in an amount in a range of from 0.1 wt.-% to 15.0 wt.-%, more preferably of from 0.25 wt.-% to 12.0 wt.-%, even more preferably of from 0.5 wt.-% to 10.0 wt.-%, still more preferably of from 0.75 to 7.5 wt.-%, yet more preferably of from 1.0 to 5.0 wt.-%, in each case based on the total weight of the composition.

Preferably, in particular when the optionally coated substrate used in step 1) is a metal substrate, the solventborne composition used in step 1) comprises constituent a2) in an amount in a range of from 0.50 wt.-% to 7.50 wt.-%, more preferably of from 0.75 wt.-% to 5.0 wt.-%, even more preferably of from 1.0 wt.-% to 4.0 wt.-%, still more preferably of from 1.5 to 3.5 wt.-%, in each case based on the total weight of the composition.

Preferably, in particular when the optionally coated substrate used in step 1) is a thermoplastic or fiber reinforced composite or glass substrate, the solventborne composition used in step 1) comprises constituent a2) in an amount in a range of from 0.25 wt.-% to 7.5 wt.-%, more preferably of from 0.5 wt.-% to 6.5 wt.-%, even more preferably of from 0.75 wt.-% to 6.0 wt.-%, still more preferably of from 1.0 to 5.0 wt.-%, in each case based on the total weight of the composition.

Preferably, the organic group(s) of metalate constituent a2) has 1 to 20 carbon atoms. Preferably, the organic group(s) are bonded to titanium and/or zirconium via divalent oxygen atoms. Examples of such organic groups are acetyl acetonate groups-Preferably, constituent a2) is a metal alkoxide, more preferably, wherein each alkoxide group represents a-O—C₁-C₈ group, more preferably a —O—C₃-C₈ group. Examples of alkoxide groups are n-butyl alkoxides, n-propyl alkoxides, isopropyl alkoxides. Most preferred titanates and/or zirconates are tetra-n-butyl zirconate (available under the trade name Tyzor® NBZ), tetrapropyl titanate (available under the trade name Tyzor® TPT by Dorf Ketal) and titanium acetyl acetonate (available under the trade names Tyzor® AA 75, Tyzor® AA 65 and Tyzor® AA 105 by Dorf Ketal).

Preferably, constituent a2) is a metal alkoxide, the metal of the metal alkoxide being selected from Ti and Zr. Preferably, each alkoxide group has 3 to 8, more preferably 3 to 6, even more preferably 3 to 4 carbon atoms.

### Constituent a3) of the Solventborne Composition

Constituent a3) is at least one organosilane, which is present in an amount of at most 10.0 wt.-%, based on the total weight of the composition. The at least one organosilane may be present in an at least partially hydrolyzed form thereof. If the amount of constituent a3) exceeds 10.0 wt.-%, the solventborne composition used in step 1) may show poorer adhesion promoting properties and adhesive failure may be observed. Preferably, the solventborne composition used in step 1) comprises constituent a3) in an amount of at least 0.5 wt.-%, more preferably of at least 0.75 wt.-%, even more preferably of at least 1.0 wt.-%. Preferably, the solventborne composition used in step 1) comprises constituent a3) in an amount of at most 9.5 wt.-%, more preferably of at most 7.5 wt.-%, even more preferably of at most 5.0 wt.-%. Preferably, the solventborne composition used in step 1) comprises constituent a3) in an amount in a range of from 0.1 wt.-% to 10.0 wt.-%, more preferably of from 0.25 wt.-% to 8.0 wt.-%, even more preferably of from 0.5 wt.-% to 6.0 wt.-%, still more preferably of from 0.75 to 5.0 wt.-%, yet more preferably of from 1.0 to 5.0 wt.-%, in each case based on the total weight of the composition.

Preferably, in particular when the optionally coated substrate used in step 1) is a metal substrate, the solventborne composition used in step 1) comprises constituent a3) in an amount in a range of from 0.50 wt.-% to 7.50 wt.-%, more preferably of from 0.75 wt.-% to 5.0 wt.-%, even more preferably of from 1.0 wt.-% to 4.0 wt.-%, still more preferably of from 1.5 to 3.5 wt.-%, in each case based on the total weight of the composition.

Preferably, the molar ratio of the at least one constituent a2) to the at least one constituent a3) in the solventborne composition to each other is in a range of from 1:>1.0 to 1:3.0, more preferably of from 1:1.2 to 1:2.8, in particular, when the optionally coated substrate used in step 1) is a metal substrate.

A variety of organosilanes can be used as constituent a3). The organosilanes can be monomeric, oligomeric or polymeric. In particular, when the optionally coated substrate used in step 1) is a metal substrate, monomeric silanes are preferred.

Preferably, the at least one organosilane used as constituent a3) contains (i) at least one hydrolyzable group X and (ii) at least one non-hydrolyzable organic group, which optionally and preferably bears or represents at least one functional group. The functional group such an OH-group can be present in a masked formed, e.g., can be masked by a protective group that can be eliminated under hydrolytic conditions. A preferably divalent spacer unit may be positioned between said functional group, e.g., when the functional group represents an amino group, within the non-hydrolyzable organic group, such that the functional group is not directly connected to a Si-atom. However, the functional group may be directly attached to an Si-atom as well, e.g., in case the functional group is a vinyl group. Preferably, functional groups are selected from amino groups including primary and secondary amino groups, epoxide groups, thiol groups, vinyl groups and (meth)acrylic groups.

Preferably, the at least one organosilane used as constituent a3) contains (i) at least one hydrolyzable group X and (ii) at least one non-hydrolyzable organic group, which bears at least one functional group, more preferably at least one amino group, in particular, when the optionally coated substrate used in step 1) is a metal substrate.

Preferably, the at least one organosilane used as constituent a3) contains (i) at least one hydrolyzable group X and (ii) at least one non-hydrolyzable organic group, which is bears or represents, preferably represents, at least one functional group, more preferably at least one ethylenically unsaturated group, even more preferably at least one vinyl and/or (meth)acrylic group, in particular, when the optionally coated substrate used in step 1) is a thermoplastic or fiber reinforced composite or glass substrate.

Preferably, the organosilane constituent a3) comprises at least two, preferably at least three, hydrolyzable groups X, wherein X preferably is an alkoxy group. The hydrolyzable groups X may each be identical or at least two of these groups may each be different from one another. Preferably, the hydrolyzable groups X are alkoxy groups, in particular C₁-C₄ alkoxy groups. Particularly preferred are methoxy, ethoxy, n-propoxy, iso-propoxy, n-butoxy, sec-butoxy and tert-butoxy groups. Most preferred are ethoxy groups and methoxy groups.

Preferably, the at least one organosilane constituent a3) has a number average molecular weight in a range of from 100 to 2000 g/mol, more preferably of from 150 to 1800 g/mol, even more preferably of from 180 to 1500 g/mol, still more preferably of from 200 to 650 g/mol.

The non-hydrolyzable organic group is preferably selected from the group consisting of aliphatic radicals having 1 to 24 carbon atoms, cycloaliphatic radicals having 3 to 12 carbon atoms, aromatic radicals having 6 to 12 carbon atoms, and araliphatic radicals having 7 to 18 carbon atoms, each of these radicals optionally containing or being at least one functional group, said group in turn being optionally masked with at least one protective group which can be eliminated under hydrolytic conditions. Moreover, each of the aforesaid aliphatic, cycloaliphatic, aromatic, and araliphatic radicals may contain one or more heteroatoms such as N, O and/or S, and/or heteroatom groups.

Examples of organosilanes, which have at least one non-hydrolyzable organic group selected from the group consisting of aliphatic radicals having 1 to 24 carbon atoms are methyltrimethoxysilane (MTMS), methyltriethoxysilane (MTES), methyltripropoxysilane, methyltriisopropoxysilane, ethyltrimethoxysilane, ethyltriethoxysilane, ethyltripropoxysilane, ethyltriisopropoxysilane, octyltrimethoxysilane, isobutyltriethoxysilane, isobutyltrimethoxysilane, octyltriethoxysilane, hexyltrimethoxysilane, hexyltriethoxysilane, decyltrimethoxysilane, and decyltriethoxysilane, hexadecyltrimethoxysilane, hexadecyltriethoxysilane, and also 1,2-bis(triethoxysilyl)ethane and 1,2-bis(trimethoxysilyl)ethane. Examples of organosilanes, which have at least one non-hydrolyzable organic groups selected from the group consisting of aromatic radicals having 6 to 12 carbon atoms are phenyltrimethoxysilane (PHS), phenyltriethoxysilane, phenyltripropoxysilane, and phenyltriisopropoxysilane. Examples of organosilanes, which have at least one non-hydrolyzable organic radical selected from the group consisting of araliphatic radicals having 7 to 18 carbon atoms are benzyltrimethoxysilane, benzyltriethoxysilane, benzyltripropoxysilane, and benzyltriisopropoxysilane.

The organosilane may comprise at least one Si-containing radical such as exactly one such radical (as in the case of monosilanes) or two or more such radicals (as in the case of bis- or tris-silanes) as in the case of 1,2-bis(triethoxysilyl)ethane. Also possible is the use of organosilanes, which have four, five, six or more silyl groups.

Organosilanes, which contain at least one primary and/or secondary amino group, which are in particular preferred, when the optionally coated substrate used in step 1) is a metal substrate, are, for example, 3-aminopropyltrimethoxysilane (APS), 3-aminopropyltriethoxysilane, 3-aminopropyltriisopropoxysilane, 2-aminoethyltrimethoxysilane, 2-aminoethyltriethoxysilane, 2-aminoethyltriisopropoxysilane, aminomethyltrimethoxysilane, aminomethyltriethoxysilane, aminomethyltriiso-propoxysilane, 3-(2-aminoethyl)aminopropyltrimethoxysilane (AEAPS), 3-(2-aminoethyl)aminopropyltriethoxysilane, N-(2-aminoethyl)-3-aminopropylmethyldimethoxysilane, 3-(2-aminoethyl)aminopropyltriisopropoxysilane, 2-(2-aminoethyl)aminoethyltrimethoxysilane, 2-(2-aminoethyl)aminoethyltriethoxysilane 2-(2-aminoethyl)aminoethyltriisopropoxysilane, 3-(3-aminopropyl)aminopropyltrimethoxysilane, 3-(3-aminopropyl)aminopropyltriethoxysilane, 3-(3-aminopropyl)aminopropyltriisopropoxysilane, diethylenetriaminopropyltrimethoxysilane, diethylenetriaminopropyltriethoxysilane, N-(n-butyl)-3-aminopropyltrimethoxysilane, N-(n-butyl)-3-aminopropyltriethoxysilane, N-cyclohexylaminomethyltriethoxysilane, N-cyclohexylaminomethyltrimethoxysilane, N-ethyl-γ-aminoisobutyltrimethoxysilane, N-ethyl-γ-aminoisobutyltriethoxysilane, N-(vinylbenzyl)-2-aminoethyl-3-aminopropyltrimethoxysilane hydrochloride, N-phenyl-γ-aminopropyltrimethoxysilane, N-phenyl-γ-aminopropyltriethoxysilane, γ-ureidopropyltrimethoxysilane, γ-ureidopropyltriethoxysilane, N-methyl-[3-(trimethoxysilyl)propyl]carbamate, and/or N-trimethoxysilylmethyl-O-methylcarbamate, and also bis[γ-(triethoxysilyl)propyl]amine, bis[γ-(trimethoxysilyl)propyl]amine.

Organosilanes, which contain at least one thiol group are, for example, 3-mercaptopropyltrimethoxysilane (MPTMS), 3-mercaptopropyltriethoxysilane, 3-mercaptopropyltriisopropoxysilane, 2-mercaptoethyltrimethoxysilane, 2-mercapto-ethyltriethoxysilane and/or 2-mercaptoethyltriisopropoxysilane.

Organosilanes, which contain at least one epoxide group, as an example of an hydroxyl group masked with a protective group which can be eliminated under hydrolytic conditions, are, for example, 3-glycidyloxypropyltrimethoxysilane (GLYMO), 3-glycidyloxypropyltriethoxysilane, 3-glycidyloxypropyltriisopropoxyoxysilane, 2-glycidyloxyethyltrimethoxysilane, 2-glycidyloxyethyltriethoxysilane, 2-glycidyloxyethyl-triisopropoxyoxysilane, β-(3,4-epoxycyclohexyl)ethyltrimethoxysilane, and/or β-(3,4-epoxycyclohexyl)ethyltriethoxysilane. Corresponding products are available commercially, for example, under the names Silquest® A-186 and A-187.

Preference as organosilane is given to using at least one alkoxysilane of the structural formula (I)

A-R—Si(R′)ₓ(OR″)3-ₓ (I),

where
A is a functional group that is optionally masked with a protective group which can be eliminated under hydrolytic conditions, or is H,
R is an aliphatic radical having 1 to 24 or having 1 to 12 carbon atoms, a cycloaliphatic radical having 3 to 12 carbon atoms, an aromatic radical having 6 to 12 carbon atoms or an araliphatic radical having 7 to 18 carbon atoms,
the R′ radical is selected from the group of C₁- to C₁₂-alkyl radicals,
R″ is an aliphatic radical with 1 to 4 carbon atoms, and
x=0 to 2.

An aliphatic radical R here means an organic radical which possesses no aromatic groups such as a phenyl radical for example. The aliphatic radical R may have 1 to 24 or 1 to 12 carbon atoms. Preferably the aliphatic radical R has 2 to 12, more preferably 3 to 10, carbon atoms. A cycloaliphatic radical R means an organic radical which possesses no aromatic groups such as a phenyl radical, for example. The cycloaliphatic radical R may have 3 to 12 carbon atoms, as in the case of cyclopropyl or cyclohexyl, for example. Aliphatic and cycloaliphatic radicals as well may be saturated or unsaturated. An example of such an unsaturated aliphatic radical is an ethenyl group as in the case of vinyltrimethoxysilane and/or vinyltriethoxysilane, for example. An aromatic radical R means an organic radical which is composed of aromatic groups, such as a phenylene radical, for example. The aromatic radical R may have 6 to 12 carbon atoms. An araliphatic radical R means an organic radical which has not only aromatic groups but also aliphatic groups. The araliphatic radical R may have 7 to 18 carbon atoms. A radical R such as an aliphatic radical R may in addition to carbon and hydrogen also contain heteroatoms, such as oxygen, nitrogen or sulfur. In addition, there may in each case likewise be further functional groups present, such as ester groups or urethane groups. More preferably, R is an aliphatic radical having 1 to 12 carbon atoms or having 1 to 10 carbon atoms, very preferably 1 to 8 carbon atoms, and especially 1 to 6 carbon atoms. To the skilled person it is clear that the radical R is a divalent radical.

Most preferred organosilanes are N-(2-aminoethyl)-3-aminopropylmethyldimethoxysilane (available under the trade name Dynasylan® 1401 by Evonik or Silquest A-2120 by Momentive), 3-aminopropyltrimethoxysilane (available under the trade name Dynasylan® AMMO), and 3-aminopropyltriethoxysilane (available under the trade name Dynasylan® AMEO or Silquest A-1100), in particular when the optionally coated substrate used in step 1) is a metal substrate.

Most preferred organosilanes are also vinyl-functional oligomeric silanes, in particular when the optionally coated substrate used in step 1) is a thermoplastic or fiber reinforced composite or glass substrate. These are, e.g., available under the trade names Dynasylan® 6490, Dynasylan® 6498 and Dynasylan® 6598 from Evonik. Vinyltrimethoxysilane (Dynasylan® VTMO), Vnyltriethoxysilane (Dynasylan® VTEO), and 3-Methacryloxypropyltrimethoxysilane (Dynasylan® MEMO) are particularly preferred.

Preferably, the molar ratio of constituent(s) a2) to a3) to each other is in a range of from 1:>1.0 to 1:3.0, more preferably of from 1:1.2 to 1:2.8.

### Further Optional Constituents of the Solventborne Composition

The solventborne composition may comprise one or more further optional constituents, which are different from each other and also from constituents a1) to a3).

Optionally, the composition comprises at least one colorant as constituent a4), preferably in an amount in a range of from 0 or 0.01 to 1.5 wt.-%, more preferably in an amount in a range of from 0 or 0.02 to 1.0 wt.-%, even more preferably in an amount in a range of from 0 or 0.03 to 0.75 wt.-%, still more preferably in an amount in a range of from 0 or 0.05 to 0.5 wt.-%, in each case based on the total weight of the composition, in particular when the optionally coated substrate used in step 1) is a metal substrate.

Examples of colorant are pigments and dyes. The use of dyes is particularly preferred. The colorants can be inorganic or organic, preferably organic. Most preferred are organic dyes.

The colorant can be any colorant, in particular a colorant, which is soluble in the organic solvent(s) present as constituent a1). Red colorants are the most preferred for externally applied adhesion promoters in the aerospace industry. For example, Rhodamine colorants, e.g., rhodamine B, can be used, as well as azo colorants, e.g., Macrolex® Red H by Lanxess or Keyplast® Red H by Milliken.

The colorant is preferably added such that after having applied the solventborne composition as adhesion promoter, it is visible where it is already applied. Furthermore, operators can see on the color shade whether the applied amount of adhesion promoter is correct. If too much adhesion promoter is applied, the color shade is too dark, if too less adhesion promoter is applied, the color shade is too light.

For some applications however, in particular when the optionally coated substrate used in step 1) is a thermoplastic or fiber reinforced composite or glass substrate, the presence of a colorant is not necessarily desired, e.g., for windows assembly applications: some parts of the applied adhesion promoter layer might be still visible on the transparent substrates after assembly.

Optionally, the composition comprises at least one additive selected from reactive diluents and resins such as polymeric resins and mixtures thereof as constituent a5), preferably in an amount in a range of from 0 or 0.01 to 7.5 wt.-%, more preferably in an amount in a range of from 0 or 0.02 to 6.0 wt.-%, even more preferably in an amount in a range of from 0 or 0.03 to 5.0 wt.-%, still more preferably in an amount in a range of from 0 or 0.05 to 4.0 wt.-%, in each case based on the total weight of the composition, in particular when the optionally coated substrate used in step 1) is a thermoplastic or fiber reinforced composite or glass substrate.

Reactive diluents that bear at least one epoxide groups are particularly preferred. Examples are neopentylglycol diglycidylether, 1,6-hexanediol-diglycidylether and trimethylolpropanpolyglycidylether. Preferably, the reactive diluents do not bear carbon-carbon double bonds. Nonetheless, such reactive diluents may be generally used as well.

Resins that can be used are in particular rosin resins, that can be used in modified form such as in case of maleic acid modified rosin resins, colophonium resins, polyesters and polyurethanes. The resins can be solids or liquids. In case it is a solid resin, it preferably is dissolved in at least one organic solvent first before being added to the composition.

A very preferred solventborne composition, in particular when the optionally coated substrate used in step 1) is a metal substrate, is a solventborne composition comprising, preferably consisting of,
at least one organic solvent as constituent a1) in an amount in a range of from 87.5 wt.-% to 99.0 wt.-%, more preferably of from 90.0 wt.-% to 98.0 wt.-%, even more preferably of from 92.5 wt.-% to 97.5 wt.-%, still more preferably of from 94.0 to 97.0 wt.-%, in each case based on the total weight of the composition,
constituent a2) in an amount in a range of from 0.50 wt.-% to 7.50 wt.-%, more preferably of from 0.75 wt.-% to 5.0 wt.-%, even more preferably of from 1.0 wt.-% to 4.0 wt.-%, still more preferably of from 1.5 to 3.5 wt.-%, in each case based on the total weight of the composition,
constituent a3) in an amount in a range of from 0.50 wt.-% to 7.50 wt.-%, more preferably of from 0.75 wt.-% to 5.0 wt.-%, even more preferably of from 1.0 wt.-% to 4.0 wt.-%, still more preferably of from 1.5 to 3.5 wt.-%, in each case based on the total weight of the composition, and
optionally, and preferably, constituent a4) in an amount in a range of from 0 or 0.01 to 1.5 wt.-%, more preferably in an amount in a range of from 0 or 0.02 to 1.0 wt.-%, even more preferably in an amount in a range of from 0 or 0.03 to 0.75 wt.-%, still more preferably in an amount in a range of from 0 or 0.05 to 0.5 wt.-%.

### Optional Step 2)

In optional step 2) the film obtained after step 1) is dried and/or cured.

“Drying” in the sense of the present invention preferably means physical drying by at least partial evaporation of in particular organic solvent(s) constituent a1) present in the composition used, whereas “curing” further includes a chemical reaction between at least two constituents originally present in the composition and/or between at least one constituent originally present in the composition and a suitable functional group present on the surface of the substrate.

Drying and/or curing may be preferably performed, e.g., at a temperature in the range of 15 °C to 80 °C, more preferably at a temperature in the range of 18 °C to 60 °C, in particular at a temperature in the range of 20 or 23 °C to 50 °C. Preferably, however, drying and/or curing is simply performed at room temperature (15 to 23 °C), preferably by air blowing. Drying and/or curing preferably is performed for a period of 5 minutes to 30 minutes, more preferably of 10 minutes to 30 minutes. The length to be selected depends on the surrounding temperature and humidity. A dried and/or cured film represents a layer.

Preferably, by performing optional step 2) constituents a2) and/or a3) bind to the substrate surface and hydrolysis reactions occur. The hydrolyzed constituents then form an adhesion promoting layer. As already outlined hereinbefore in connection with step 1), the resulting dry layer thickness preferably is below 1.0 μm, more preferably below 900 or below 800 nm, even more preferably below 700 nm or below 600 nm, still more preferably below 500 nm or below 400 nm, most preferably below 300 or 200 nm.

### Step 3)

In step 3) a sealant composition, which is different from the solventborne composition used in step 1), is applied at least in portion onto the optionally dried and/or cured film obtained after step 1) or 2) to form a sealant film.

Any kind of contacting may be used for the application according to step 3) such as brushing and/or spraying. Step 3) is preferably performed at a temperature in a range of from 0 to 60 °C, more preferably of from 5 to 45 °C. In particular, no heating is performed.

Preferably, step 3) is performed with a 2K-compressed air supported cartridge apparatus, with a 2K-low pressure or 2K-high pressure dosing system. It may also be done manually.

### Sealant Composition Used in Step 3)

The sealant composition used in step 3) is obtainable by mixing at least two separately present components A) and B) of a sealing system with each other. Preferably, the sealing system consists of components A) and B). For example, components A) and B) of the sealing system can be stored separately until they are mixed with each other in order to prepare the sealant composition. Component A) of the sealing system comprises at least one polymeric constituent A1) containing two or more thiol groups, which is selected from polyether, polythioether, polysulfide, polythioether-sulfide constituents and mixtures thereof, and component B) of the sealing system comprises at least one constituent B0), which is suitable for curing the sealant composition by at least partially inducing a chemical transformation of the two or more thiol groups of constituent A1).

Each of the two components A) and B) of the sealing system may contain water and/or at least one organic solvent. However, it is also possible and even preferably if no organic solvents and/or water are present therein.

The amount of water present in component A) preferably is less than 3.0 wt.-%, more preferably less than 2.0 wt.-%, even more preferably less than 1.0 wt.-%, still more preferably less than 0.5 wt.-%, in each case based on the total weight of component A). The amount of water present in component (B) when at least one constituent B1) and/or at least one constituent B3) and/or at least one constituent b4) is present in each case as constituent B0) in B) preferably is less than 3.0 wt.-%, more preferably less than 2.0 wt.-%, even more preferably less than 1.0 wt.-%, still more preferably less than 0.5 wt.-%, in each case based on the total weight of component B). Constituents B1), B3) and B4) will be defined hereinafter. The amount of water present in component B) when at least one constituent B2) such as manganese dioxide is present as constituent B0) in B) preferably is less than 8.5 wt.-%, more preferably less than 7.5 wt.-%, even more preferably less than 7.0 wt.-%, still more preferably less than 6.0 wt.-%, in each case based on the total weight of component B). Constituent B2) will be defined hereinafter.

If at least one organic solvent is present therein, organic solvent(s) are preferably present in an amount of up to 70 wt.-% or up to 65 wt.-%, based on the total weight of the sealant composition, in particular when the sealant composition is a sprayable composition. In this case the sealant composition preferably includes an organic solvent(s) fraction of up to 60 wt.-%, based in each case on the total weight of the composition. Alternatively, if at least one organic solvent is present therein, in particular, when the sealant composition is not a sprayable composition, organic solvent(s) are preferably present in an amount of up to 10 wt.-%, based on the total weight of the sealant composition. The sealant composition in this case preferably includes an organic solvent(s) fraction of up to 7.5 wt.-%, more preferably of up to 5 wt.-%, based in each case on the total weight of the composition. All conventional organic solvents known to those skilled in the art can be used as organic solvents. The term “organic solvent” is known to those skilled in the art, in particular from Council Directive 1999/13/EC of 11 Mar. 1999. Examples of such organic solvents would include heterocyclic, aliphatic, or aromatic hydrocarbons, mono- or polyhydric alcohols, especially ethanol and/or propanol, ethers, esters, ketones, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof. The solvents present may be identical or different from one another.

Preferably, the sealing composition is obtainable by mixing components A) and B) in a weight ratio (component A)/component B)) in the range of from 100:1 to 1:1. More preferably, mixing is performed in a weight ratio in the range of from 100:1 to 1.1:1, even more preferably in a weight ratio in the range of from 100:1 to 2:1, in particular in a weight ratio in the range of from 100:1 to 3:1, most preferred in a weight ratio in the range of from 20:1 to 4:1.

### Component A) of the Sealing System

### Constituent A1)

Component A) of the sealing system comprises at least one polymeric constituent A1) containing two or more thiol groups (mercapto groups) selected from polyether, polythioether, polysulfide, polythioether-sulfide constituents and mixtures thereof, preferably is selected from polythioether, polysulfide, polythioether-sulfide constituents and mixtures thereof, more preferably is selected from polythioether, polysulfide constituents and mixtures thereof, in particular is selected from polysulfide constituents. The terms “polymer” and “polymeric” are known to the person skilled in the art and, for the purposes of the present invention, encompasses polyadducts and polymerizates as well as polycondensates. The term “polymer” includes both homopolymers and copolymers.

Due to the presence of the thiol groups, A1) is necessarily a sulfur atoms containing constituent. The thiol groups of A1) can be chemically reacted with constituent B0) or part of it, e.g., with suitable functional groups thereof. For example, when a constituent B1) is present as constituent BC), the epoxide groups thereof can be reacted and at least one of hydroxythioether, hydroxythioethersulfide and/or hydroxysulfide moieties are formed. For example, when a constituent B2) is present as constituent BC) such as contains manganese oxide, S—S-bonds are formed.

Preferably, polymeric constituent A1) contains terminal thiol groups. Constituent A1) may be branched or linear. Preferably, polymeric constituent A1) is liquid at ambient conditions (18 to 23 °C, 50% relative humidity).

Polymeric constituents suitable for use as A1) are, e.g., disclosed in US 2004/097643 A1 and WO 2016/128548 A1 as well as in WO 2015/014876 A2.

If at least one polythioether is used as A1) it preferably is a liquid (at ambient conditions) polythioether. The polythioether may contain possibly up to about 50 mol-% of disulfide groups within the molecule. The respective polymers may then be named polythioethersulfides. Preferred compounds of this kind are described in WO 2015/014876 A2.

Preferably, polymeric constituent A1) has a number average molecular weight in a range of from 500 to 10 000 g/mol, more preferably of from 900 to 5000 g/mol. Most preferred is a number average molecular weight in a range of from 2500 to 6 000 g/mol, more preferably of from 3300 to 5000 g/mol, especially when A1) is at least one polysulfide. Examples for such polymers are, e.g., polysulfides commercially available, e.g., under Thioplast® G131, Thioplast® G10, Thioplast® G12, Thiokol® LP 32 and/or Thiokol® LP 12. Preferred is also a polymer constituent A1) having a number average molecular weight in a range of from 500 to 2 500 g/mol, more preferably of from 700 to 2000 g/mol or 800 to 1200 g/mol. In this case examples for such polymers are, e.g., polysulfides commercially available, e.g., under Thiokol® LP3, Thioplast® G4, or Thioplast® G44.

Optionally, at least two kinds of constituents A1) are present in component (A) having a different number average molecular weight: Long-chain polymers with a number average molecular weight in particular in the range from 2500 to 6000 g/mol, particularly preferably in the range from 3300 to 5000 g/mol, may be present besides short chain polymers with a number average molecular weight in particular in the range from 500 to 2500 g/mol, particularly preferably in the range from 800 to 1500 g/mol. Optionally, at least one of the aforementioned short chain polymers used in combination with the at least one aforementioned long chain polymer may be replaced by at least one polymeric, oligomeric or monomeric mercaptane, which preferably is solid or liquid, having three thiol groups and a number average molecular weight in a range of from 160 to 1200 g/mol. Alternatively, said mercaptane may be further added to the combination of the at least one short chain polymer and the at least one long chain polymer. Examples of such suitable mercaptanes are thiocyanuric acid (1,3,5-triazine-2,4,6-trithiol) and benzene-1,3,5-trithiol (1,3,5-trimercaptobenzene). In case said mercaptane used is non-polymeric, it formally represents an optional constituent A6) of component A), which will be defined hereinafter. Preferably, said at least one mercaptane—if present—is present in an amount in a range of from 0.05 to 3.0 wt.-%, based on the total weight of component A).

The sulfur containing polymeric constituents A1) preferably have a mercaptan content referred to reactive SH-groups with respect to the total weight of A1) in the range of from 0.5 to 10.0 wt.-%, more preferably of from 0.8 to 8.0 wt.-%, in particular of from 1.2 to 7.0 wt.-%. The mercaptan content can be determined by direct titration of the SH-terminated polymers with an iodine solution: The polymers are dissolved in a solvent mixture composed of 40% in volume of pyridine and 60% in volume of benzene, and are titrated by stirring with a benzene iodine solution, until a weak yellow coloration remains. Preferably, constituent A1) has a total sulfur content in the range of from 1 to 50 wt.-%, more preferably of from 5 to 45 wt.-%, in particular of from 12 to 36 wt.-%. Preferably, constituent A1) has an average functionality as reactive end groups of mercapto-groups per molecule in the range from 1.5 to 2.5 or from 1.9 to 2.2. The functionality indicates the average number of mercapto groups per molecule. It is calculated as the ratio of molecular weight to equivalent weight and may be determined by NMR. Preferably, constituent A1) has an average glass transition temperature T_{g} in the range of from −80 to −30 °C or of from −60 to −40 °C, measured according to the AITM 1-0003 Airbus Industrie Test Method, June 1995.

Preferably, component A1) and the sealant composition as such are free from any constituents comprising (meth)acrylate groups (methacrylate and/or acrylate groups).

Preferably, constituent A1) is present in the sealant composition obtained after having mixed components A) and B) of the sealing system with each other in an amount in a range of from 50 to 95 wt.-%, based on the total weight of the sealant composition.

### Optional Constituents Present in Component A)

Component A) may optionally additionally contain at least one organosilane A2), at least one filler A3) and/or at least one pigment A4). The organosilane A2) may be identical to or different from constituent a3) defined hereinbefore and hereinafter.

The term “filler” is known to the skilled person, from DIN 55943 (date: October 2001), for example. A “filler” for the purposes of the present invention is preferably a constituent, which is substantially, preferably entirely, insoluble in the medium surrounding them, such as each of components A) and B) and the sealant composition, for example, and which is used in particular for adjusting the viscosity and thixotropy of the components and the sealant composition, for adjusting the specific density of the cured sealant and/or for increasing the mechanical properties of the cured sealant. “Fillers” in the sense of the present invention differ from “pigments” in their refractive index, which for fillers is <1.7, while the refractive index for pigments is 1.7. Preferably, a “filler” for the purposes of the present invention is an inorganic and/or organic filler. Examples of inorganic fillers are chalk and talcum. Examples of organic fillers are powders prepared from temperature resistant polymers such as polyamides, polysulfones, polyphenylene sulfides, polyetherketones and polymeric hollow spheres. Preferably, the amounts of fillers present in component A) of the sealing system is in the range of from 0 to 55.0 wt.-%, more preferably in the range of from 0 to 50.0 wt.-%, even more preferably in the range of from 0 to 45.0 wt.-%, still more preferably in the range of from 0 to 40.0 wt.-%, yet more preferably in the range of from 0 to 35.0 wt.-% or of from 0 to 30.0 wt.-%, in particular in the range of from 0 to 25.0 wt.-%, in each case based on the total weight of component A). Preferably, the amounts of any pigments present in component A) of the sealing system is in the range of from 0 to 35.0 wt.-%, more preferably in the range of from 0 to 30.0 wt.-%, even more preferably in the range of from 0 to 25.0 wt.-%, still more preferably in the range of from 0 to 20.0 wt.-%, yet more preferably in the range of from 0 to 15.0 wt.-%, in each case based on the total weight of component A). The term “pigment” is known to the skilled person from DIN 55943 (date: October 2001), for example. A “pigment” in the sense of the present invention refers preferably to components in powder or flake form which are substantially, preferably entirely, insoluble in the medium surrounding them, such as each of components A) and B) and the sealant composition, for example, and which is a colorant and/or substance which can be used as pigment on account of their magnetic, electrical and/or electromagnetic properties. Preferably, a “pigment” for the purposes of the present invention is an inorganic and/or organic pigment. An example of an inorganic pigment is titanium dioxide.

Component A) of the sealing system may contain one or more optional constituents A5 and/or A6).

Component A) may additionally contain and preferably contains at least one curing catalyst A5), when component B) of the sealing system comprises at least one constituent B1) comprising two or more epoxide groups as constituent BC). Suitable curing catalysts are amines, in particular tertiary amines, amidines and/or guanidines. Examples are 1,4-diazabicyclo(2.2.2)octane, 1,5-diazabicyclo(4.3.0)non-5-ene (DBN) and 1,8-diazabicyclo(5.4.0)undec-7-ene (DBU).

Constituent A6) may be a flame retardant such as a phosphorous-containing flame retardants, in particular at least one phosphate ester. If a flame retardant is used, it preferably is liquid (at 1 bar and 23 °C). In case a flame retardant is present in component A), it is preferably present therein in an amount of 0.1 to 30.0 wt.-%, more preferably of 1.0 to 25.0 wt.-%, in particular of 5.0 to 20.0 wt.-%, based on the total weight of component A). Constituent A6) may be a light stabilizer, in particular a UV stabilizers. Examples are for instance sterically hindered amines (HALS: hindered amine light stabilizer). In principle, all commercially available light stabilizers of the Tinuvin® series or from other manufacturers can be used. Liquid light stabilizers are preferred. In case a light stabilizer is present in component A), it is preferably present therein in an amount of 0.05 to 5.0 wt.-%, more preferably of 0.1 to 3.5 wt.-%, in particular of 0.1 to 2.0 wt.-%, based on the total weight of component A). Constituent A6) may be an additional adhesion promoter besides the optionally present aforementioned organosilane constituent A2). Additionally or alternatively, other adhesion promoters may be used such as the ones subsumable under constituent a2) defined hereinbefore and hereinafter. In case an additional adhesion promoter is present in component A), it is preferably present therein in an amount of 0.05 to 5.0 wt.-%, more preferably of 0.1 to 3.5 wt.-%, in particular of 0.1 to 2.0 wt.-%, based on the total weight of component A). Constituent A6) may be an additive selected from the group consisting of defoamers, rheological additives, plasticizers such as phthalates, and viscosity reducers, in particular non-reactive viscosity reducers such as hydrocarbon mixtures based on naphthalene derivatives and/or indene-coumarone resins, tall oil and rapeseed methyl ester (biodiesel) and rapeseed oil and/or other ester-based diluents, as well as mixtures of such additives. In case at least one additive is present in component A), it is preferably present therein in an amount of 0.05 to 40.0 wt.-%, more preferably of 0.1 to 30.0 wt.-%, in particular of 0.1 to 20.0 wt.-%, based on the total weight of component A). Specifically, in case at least one defoamer is present, its amount is preferably in the range of from 0.1 to 2.5 wt.-%, based on the total weight of component A). Specifically, in case at least one reactive diluent is present, its amount is preferably in the range of from 0.1 to 20.0 wt.-%, based on the total weight of component A). Specifically, in case at least one rheological additive is present, its amount is preferably in the range of from 0.1 to 5.0 wt.-%, based on the total weight of component A). Specifically, in case at least one plasticizer is present, its amount is preferably in the range of from 0.1 to 2.5 wt.-%, based on the total weight of component A). Specifically, in case at least one viscosity reducer is present, its amount is preferably in the range of from 0.1 to 20.0 wt.-%, based on the total weight of component A). As outlined hereinbefore in connection with constituent A1), constituent A6) may further be at least one non-polymeric mercaptane having three thiol groups and a number average molecular weight in a range of from 160 to 800 g/mol. Preferably, said at least one non-polymeric mercaptane—if present—is present as constituent A6) in an amount in a range of from 0.05 to 3.0 wt.-%, more preferably of from 0.05 to 1.5 wt.-%, in each case based on the total weight of component A).

### Component B) of the Sealing System

### Constituent B0)

Component B) of the sealing system comprises at least one constituent B0), which is suitable for hardening the sealant composition by at least partially inducing a chemical transformation of the two or more thiol groups of constituent A1). In other words, constituent B0) or part of it can be chemically reacted with the thiol groups of constituent A1). Constituent B0) thus represents a curing agent. The resulting chemical transformation may apply to all thiol groups of constituent A1) or to only part of the thiol groups of constituent A1). Preferably, however, a chemical transformation is not only induced partially, but substantially to all thiol groups of constituent A1).

Preferably, the least one constituent B0) is selected from the group consisting of constituents comprising two or more epoxide groups (constituents B1)), constituents, which are metal oxides and/or metal peroxides, in particular manganese dioxide, (constituents B2)), constituents, which are organic peroxides (constituents B3)), constituents comprising two or more vinyl groups (constituents B4), and mixtures thereof, more preferably is selected from the group consisting of constituents comprising two or more epoxide groups (constituents B1l)), constituents, which are metal oxides and/or metal peroxides, in particular manganese dioxide, (constituents B2)), and mixtures thereof, in particular represents either at least one constituent comprising two or more epoxide groups as constituent B1) or represents at least one metal oxide and/or metal peroxide, in particular manganese dioxide, as constituent B2).

Preferably, constituent B0) is present in component B) of the sealing system used for preparing the sealant composition applied in step 3) in an amount in a range of from to 100 wt.-%, based on the total weight of component B).

### Constituent B1)

Constituent B1) comprises two or more epoxide groups. Preferably, the epoxide groups are present in B1) as terminal groups. Constituent B1) can be monomeric, oligomeric, or polymeric. Preferably, B1) is aliphatic and/or aromatic.

Preferably, constituent B1) is present in component B) of the sealing system used for preparing the sealant composition applied in step 3) in an amount in a range of from 50 to 100 wt.-%, based on the total weight of component B). Preferably, B1) has an epoxide functionality of from 2.0 to 5.0, more preferably of from 2.0 to 3.0, in particular of from 2.2 to 2.8.

Constituent B1) is particularly selected from diglycidyl ethers of bisphenol A, diglycidyl ethers of bisphenol F and aliphatic polyglycol and/or hydantoin epoxy derivatives. Also, epoxy-terminated polythioether or polythioethersulfide and/or epoxidized polysulfides may be used. Particularly preferred is also at least one epoxy-novolac resin (epoxidized phenol formaldehyde resin), preferably a cross-linked epoxy novolac resin. It is also possible that more than constituents B1) can be used based on several of the abovementioned classes, for example, bisphenol A/F epoxy resin or bisphenol F novolac resin. Component B) may additionally contain diluting agents in order to adjust the viscosity and flexibility, for example. Examples of diluting agents are 1,4-butanediol diglycidyl ether, 2-ethylhexyl-glycidyl ether and 1,6-hexanediol diglycidyl ether.

Preferably, B1) is at least one epoxide-terminated polysulfide polymer and/or polythioether polymer and/or polythioethersulfide polymer without terminal mercapto groups, which serves as a curing agent due to its two terminal epoxide groups. This polymer is preferably present as a liquid or highly viscous polymer with an epoxy equivalent weight in particular in the range from 200 to 800 g/eq. Preferably, the epoxy (epoxide) equivalent weight of B1) is in the range of from 120 to 800 g/eq, particularly preferably in the range of from 140 to 700 g/eq, and most preferably in the range of from 170 to 400 g/eq.

Most particularly preferred are constituents B1) based on bisphenol A epoxy resins having an epoxy equivalent weight in the range from 170 to 200 g/eq, based on bisphenol F resin having an epoxy equivalent weight in the range from 150 to 180 g/eq and based on epoxy novolac resins having an epoxy equivalent weight in the range from 160 to 220 g/eq. Examples of suitable commercial products are e.g. bisphenol F epoxy resins such as DEN 354 (Olin Epoxy), bisphenol A resins such as DER 336, DER 331 (Olin Epoxy), bisphenol A/F epoxy resins such as DER 351, DER 324, DER 335 (Olin Epoxy), epoxy novolac resins such as DEN 431, DEN 438, DEN 439 (Olin Epoxy), epoxy-terminated prepolymers based on polysulfide and/or polythioether such as Thioplast EPS 25 (Akzo Nobel), epoxy-terminated reactive diluents based on alcohol/glycols such as 1,4-butanediol diglycidyl ether (DER 731; Olin Epoxy), and 1,6-hexanediol diglycidyl ether (DER 734; Olin Epoxy).

Preferably, the molar ratio of all constituents B1) to all constituents A1) is in a range of from 0.90:1 to 2:1.

### Constituent B2)

Constituent B2) is at least one metal oxide and/or metal peroxide, in particular manganese dioxide. Manganese dioxide means manganese (IV) oxide. Another suitable constituent B2) is calcium peroxide.

Preferably, constituent B2) is present in component B) of the sealing system used for preparing the sealant composition applied in step 3) in an amount in a range of from to 90 wt.-%, based on the total weight of component B).

### Constituent B3)

Constituent B3) is at least one organic peroxide. Examples of suitable organic peroxides are organic hydroperoxides such as cumenyl hydroperoxide.

Preferably, constituent B3) is present in component B) of the sealing system used for preparing the sealant composition applied in step 3) in an amount in a range of from to 100 wt.-%, based on the total weight of component B).

### Constituent B4)

Constituent B4) comprises two or more vinyl groups. Preferably, the vinyl groups are present in B4) as terminal groups. Constituent B4) can be monomeric, oligomeric or polymeric, and preferably is monomeric. Preferably, B4) is aliphatic and/or aromatic. Examples of constituent B4) are divinyl ethers such as diethyleneglycol divinyl ether, triethyleneglycol divinyl ether and butandiol divinyl ether.

Preferably, constituent B4) is present in component B) of the sealing system used for preparing the sealant composition applied in step 3) in an amount in a range of from 30 to 100 wt.-%, based on the total weight of component B).

If constituent B4) is used as constituent BC) of component B), it preferably is present in combination with at least one radical generator. Examples of suitable radical generators are 1-hydroxycyclohexyl phenylketone and 2-hydroxy-2-methyl-1-phenylpropane-1-one.

### Optional Constituents B5) and B6) and B7)

Component B) of the sealing system may contain one or more optional constituents B5). Constituent B5) may be an additive selected from the group consisting of reactive diluents such as bis-oxazolidines and/or aldimines, and plasticizers such as phthalates. In particular, at least one plasticizer constituent B5) is present in component B), when component B) of the sealing system comprises at least one constituent B2), in particular manganese dioxide.

Specifically, in case at least one reactive diluent is present, its amount is preferably in the range of from 0.1 to 20.0 wt.-%, based on the total weight of component B). Specifically, in case at least one plasticizer is present, its amount is preferably in the range of from 10.0 to 70.0 wt.-%, based on the total weight of component B).

Component B) may contain and preferably contains at least one curing catalyst B6). As outlined hereinbefore, when component B) of the sealing system comprises at least one constituent B1) comprising on turn two or more epoxide groups as constituent BC), at least one curing catalyst if present is preferably present in component A) as constituent A5) and is not present in component B). Suitable curing catalysts in this case are amines, in particular tertiary amines, amidines and/or guanidines. Examples are 1,4-diazabicyclo(2.2.2)octane, 1,5-diazabicyclo(4.3.0)non-5-ene (DBN) and 1,8-diazabicyclo(5.4.0)undec-7-ene (DBU).

When component B) of the sealing system comprises at least one constituent B2) as constituent BC), at least one curing catalyst B6) is preferably present in component B). Suitable curing catalysts in this case are, e.g., tetrabenzylthiuram disulfide, diphenylguanidine, and/or zinc bis(diethyldithiocarbamate).

When component B) of the sealing system comprises at least one constituent B3) as constituent BC), at least one curing catalyst B6) is preferably present in component B). Suitable curing catalysts in this case are, e.g., zinc bis(diethyldithiocarbamate).

When component B) of the sealing system comprises at least one constituent B4) as constituent BC), at least one curing catalyst B6) is preferably present in component B). Suitable curing catalysts in this case are in particular suitable photoinitiators such as acetophenones, benzoin ethers and/or benzoyl oximes. Curing preferably takes place via UV light.

Component B) may contain at least one flame retardant B7). Constituent B7) may be a phosphorous-containing flame retardant, in particular at least one phosphate ester. If a flame retardant is used, it preferably is liquid (at 1 bar and 23 °C). In case a flame retardant is present in component A), it is preferably present therein in an amount of 5.0 to 65.0 wt.-%, more preferably of 25.0 to 65.0 wt.-%, in particular of 40.0 to 65.0 wt.-%, based in each case on the total weight of component B).

### Optional Step 4)

In optional step 4) the sealant film obtained after step 3) is cured. Preferably, curing is performed at ambient temperature (18 to 23 °C) or at an elevated temperature such as 80 °C for 0.5 hours to 14 days.

Preferably, curing according to optional step 4) means chemical curing such as chemical crosslinking, at ambient temperature or at an elevated temperature. In case of using at least one constituent B1) or B4) as constituent B0), curing may additionally or alternatively be induced via UV light.

Preferably, the sealant composition is applied in a dry layer thickness in the range of from 15 μm to 20 mm, more preferably of from 50 μm to 15 mm, in particular of from 0.5 to 10 mm.

### Sealed Substrate

A further subject-matter of the present invention is a sealed substrate, obtainable by the inventive method, which is preferably suitable for use in the aircraft and/or aerospace industry.

All preferred embodiments described above herein in connection with the inventive method and the preferred embodiments thereof, are also preferred embodiments of the inventive sealed substrate.

### Use as Adhesion Promoter

A further subject-matter of the present invention is a use of the solventborne composition as used and defined in step 1) of the aforementioned method as adhesion promoting composition, in particular for enhancing adhesion between the surface of an optionally pre-coated substrate and a subsequently applied sealant film.

All preferred embodiments described above herein in connection with the inventive method and the inventive sealed substrate and the preferred embodiments thereof, are also preferred embodiments of the inventive use.

The sealant film is preferably obtained in the manner as defined in step 3) of the aforementioned method, in particular by applying a sealant composition obtainable by mixing at least two separately present components A) and B) of a sealing system with each other, wherein component A) of the sealing system comprises at least one polymeric constituent A1) containing two or more thiol groups, which is selected from polyether, polythioether, polysulfide, polythioether-sulfide constituents and mixtures thereof, and wherein component B) of the sealing system comprises at least one constituent b), which is suitable for curing the sealant composition by at least partially inducing a chemical transformation of the two or more thiol groups of constituent A1), onto a film already present on a surface of the optionally pre-coated substrate, said film having been formed by applying the solventborne composition as defined in step 1) of the aforementioned method at least in portion onto said surface.

### Solventborne Composition

A further subject-matter of the present invention is a solventborne composition as defined in connection with step 1) of the aforementioned method as such.

All preferred embodiments described above herein in connection with the inventive method, the inventive sealed substrate, and the inventive use, and the preferred embodiments thereof, are also preferred embodiments of the inventive solventborne composition.

### Kit-of-Parts

A further subject-matter of the present invention is a kit-of-parts comprising separated from one another, preferably consists of separated from one another, at least a sealing system as defined in connection with step 3) of the aforementioned method comprising at least two components A) and B) being separate from each other, and a solventborne composition as defined in connection with step 1) of the aforementioned method or an inventive solventborne composition.

All preferred embodiments described above herein in connection with the inventive method, the inventive sealed substrate, the inventive use, and the inventive composition, and the preferred embodiments thereof, are also preferred embodiments of the inventive kit-of-parts.

### METHODS

### 1. Peel Test

Peels were produced and tested in equivalence to DIN 65262-1 (07-2017) after curing for 14 days at room temperature (23 °C) and 50% relative humidity. It is evaluated whether cohesive or adhesive failure occurs.

### 2. Number Average Molecular Weight

The number average molecular weight of constituents A21) and B1) is determined through GPC (gel permeation chromatography) against polystyrene standards. THF (tetrahydrofurane) is used as a mobile phase. The number average molecular weight of organosilane constituents A2) and a3) is determined through NMR spectroscopy in case of monomeric and oligomeric constituents and is determined via GPC in case of polymeric constituents.

### 3. Flashpoint

The device Miniflash FLPL was used to determine the flashpoint according to ASTM D6450.

### 4. Dry Layer Thickness

The dry layer thicknesses, in particular of films obtained after optional step 2) of the inventive method, were measured using REM/EDX (scanning electron microscope/energy dispersive X-ray analysis).

### Examples

The following examples further illustrate the invention but are not to be construed as limiting its scope. ‘Pbw’ means parts by weight. If not defined otherwise, ‘parts’ means ‘parts by weight’.

### 1. Adhesion Promoting Compositions

1.1 An exemplary composition E1 was prepared from mixing the constituents listed in Table 1.1 with each other in the order given in Table 1.1.

TABLE 1.1
Composition E1

| Position | Constituent | Amount [wt.-%] |
|---|---|---|
| 1 | 1-Ethoxy-2-propanol | 75.03 |
| 2 | 2-Methyl-2,4-pentanediol | 19.98 |
| 3 | Zirconate 1 | 2.49 |
| 4 | Silane 1 | 2.49 |
| 5 | Dye 1 | 0.01 |

A commercial product comprising zirconium tetra-n-butanolate (87 wt.-%) in n-butanol was used as zirconate 1. A commercially available xanthenyl-based colorant was used as dye 1. Silane 1 is a commercially available organosilane, namely N-(2-aminoethyl)-3-aminopropylmethyldimethoxysilane.

Composition E1 was prepared as follows: The organic solvents used were weighed into a closable glass bottle. Then, zirconate 1 was added. The glass bottle was closed and shaken carefully. Next, silane 1 was added. The glass bottle was closed and shaken carefully. Finally, dye 1 was added. The glass bottle was closed and shaken carefully.

1.2 Further exemplary compositions E2 and E3 as well as a comparative composition C1 were prepared from mixing the constituents listed in Table 1.2 with each other in the order given in Table 1.2.

TABLE 1.2
Compositions E2, E3 and C1

| | | Composition | Composition | Composition |
|---|---|---|---|---|
| Position | Constituent | E2 [wt.-%] | E3 [wt.-%] | C1 [wt.-%] |
| 1 | 1-Ethoxy-2- | 74.94 | 78.49 | 99.42 |
| | propanol | | | |
| 2 | 2-Methyl-2,4- | 19.98 | 20.93 | — |
| | pentanediol | | | |
| 3 | Zirconate 1 | 2.50 | 0.25 | 0.25 |
| 4 | Silane 1 | 2.50 | 0.25 | 0.25 |
| 5 | Dye 2 | 0.08 | 0.08 | 0.08 |

A commercial product comprising zirconium tetra-n-butanolate (87 wt.-%) in n-butanol was used as zirconate 1. A commercially available azo-based red colorant was used as dye 2. Silane 1 is a commercially available organosilane, namely N-(2-aminoethyl)-3-aminopropylmethyldimethoxysilane.

In composition C1 the diol used was completely replaced by monoalcohol compared to composition E3.

1.3 Further comparative compositions C2, C3 and C4 were prepared from mixing the constituents listed in Table 1.3 with each other in the order given in Table 1.3.

TABLE 1.3
Compositions C2, C3 and C4

| | | Composition | Composition | Composition |
|---|---|---|---|---|
| Position | Constituent | C2 [wt.-%] | C3 [wt.-%] | C4 [wt.-%] |
| 1 | 1-Ethoxy-2- | 99.42 | 99.42 | — |
| | propanol | | | |
| 2 | 2-Methyl-2,4- | — | — | — |
| | pentanediol | | | |
| 3 | Isopropanol | — | — | 99.42 |
| 4 | Zirconate 2 | 0.25 | 0.25 | 0.25 |
| 5 | Silane 1 | 0.25 | — | 0.25 |
| 6 | Silane 2 | — | 0.25 | — |
| 7 | Dye 2 | 0.08 | 0.08 | 0.08 |

A commercial product comprising zirconium tetra-n-propanolate (74 wt.-%) in n-propanol was used as zirconate 2. A commercially available azo-based red colorant was used as dye 2. Silane 1 is a commercially available organosilane, namely N-(2-aminoethyl)-3-aminopropylmethyldimethoxysilane. Silane 2 is a commercially available organosilane, namely N-(2-aminoethyl)-3-aminopropyltrimethoxysilane.

### 2. Investigation of Properties of the Adhesion Promoting Compositions

The flashpoints of each of adhesion promoting compositions E2, E3 and C₁ to C₄ were determined according to the method disclosed in the ‘method’ section. The results are shown in Table 2. The higher the flashpoint is, the lower is the hazard potential. Hence, higher flashpoints, in particular flashpoints >40 °C, are desirable.

TABLE 2
Flashpoints

| Composition | Flashpoint [°C] |
|---|---|
| E2 | 41 |
| E3 | 41 |
| C1 | 37 |
| C2 | 37 |
| C3 | 37 |
| C4 | 16 |

As it is evident from Table 2 the use of mixtures of a diol and a monoalcohol as organic solvents in compositions E2 and E3 leads to a sufficiently high flashpoint of >40 °C, i.e., of 41 °C in both cases. A comparison between E2 and E3 shows that a reduction of the amount of zirconate and silane has no effect on the flashpoint.

A comparison between E3 and C1 shows that using only a monoacohol and no diol leads to an undesired drop of the flashpoint below 40 °C, i.e., to 37 °C. The use of a different zirconate or a different silane does not effect this as it is evident from a comparison of the flashpoints of C1, C2 and C3. The use of isopropanol as only alcohol being present leads to further severe drop of the flashpoint and to a very low flashpoint of only 16 °C as it is evident from a comparison of the flashpoints of C1 and C4.

3. Preparation of Sealed Substrates and Investigation of their Properties

### Sealed Substrates Prepared by Making Use of Exemplary Adhesion Promoting Composition E1

A number of substrates S1 to S8 were provided, namely titanium grade 5 (S1), stainless steel 304 (S2), aluminum 2024 T3 clad (S3), a carbon fiber composite (CFC) material, namely HexPly® M21E (S4), a substrate S3 coated with a commercially available primer coat, namely with Mankiewicz Seevenax 313-02 (S5), a substrate S3 coated with a commercially available primer coat, namely with Akzo® 37092 (S6), a substrate S3 coated with a commercially available polyurethane topcoat, namely with Akzo® HS 67348 (S7) and a substrate S3 coated with a commercially available polyurethane topcoat, namely with Akzo® C21/100 (S8).

Each of the substrates S1 to S8 was cleaned with an appropriate solvent (mixture) according to the recommendations of the substrate manufacturer. Any dirt, grease, oil or dust was removed in this manner from the substrate surface prior to the subsequent application of the adhesion promoting composition.

Adhesion promoting composition E1 was then applied to the cleaned surface of each of the substrates by a “wipe-on/wipe-off” method in a very thin layer (dry layer thickness ≤200 nm) This method means that adhesion promoting composition E1 was applied in excess onto the surface of the substrates by brush, soft lint-free wipes, or by suitable pens with a felt. Within a few seconds or minutes (depending on the substrate used) the excess is wiped off with a soft lint-free wipe followed by a flash-off time, during which at least parts of the organic solvents present could evaporate and hydrolysis reactions involving the constituents being present in applied composition E1 were allowed to take place. The length of the flash-off time depends on the surrounding temperature and humidity. Here, a flash-off time of 30 minutes was used.

Afterwards an aerospace sealant was applied on top. In all cases, the commercially available sealant Naftoseal® MC-238M B-2 (available from Chemetall GmbH) was used, which is a two-component, manganese-dioxide cured, liquid polysulfide sealant. After having been applied to the surfaces of the substrates the applied sealants were cured for 14 days at room temperature (23 °C) and 50% relative humidity. The sealed substrates were then subjected to a peel test according to the method disclosed in the ‘method’ section. The results are summarized hereinafter in Table 3. C.f. means cohesive failure.

TABLE 3
Peel test results

| | Peel test I result |
|---|---|
| Substrate | [N/25 mm] |
| S1, E1 | 296 (100% c.f.) |
| S2, E1 | 322 (100% c.f.) |
| S3, E1 | 320 (100% c.f.) |
| S4, E1 | 295 (100% c.f.) |
| S5, E1 | 303 (100% c.f.) |
| S6, E1 | 302 (100% c.f.) |
| S7, E1 | 306 (100% c.f.) |
| S8, E1 | 284 (100% c.f.) |

It is evident from Table 3, that 100% adhesion could be achieved for the variety of tested different substrates S1 to S8 by using adhesion promoting composition E1 (no adhesive failure was observed, only c.f.). E1 has a lower toxicity compared to other adhesion promoters on the market (e.g., compared to Naftoseal® MC-110 and Naftoseal® MC-115) and, further, performs as efficiently even though it possesses a lower active ingredient content compared to Naftoseal® MC-110 and Naftoseal® MC-115. In addition, E1 has a higher flashpoint, namely of >40 °C, compared to each of Naftoseal® MC-110 and Naftoseal® MC-115, which have each a flashpoint of <40 °C.

1. A method of sealing an optionally pre-coated substrate comprising at least steps 1) and 3) and optionally at least one of steps 2) and/or 4):
1) applying a solventborne composition at least in portion onto a surface of an optionally pre-coated substrate to form a film at least in portion on said surface,
2) optionally drying and/or curing the film obtained after step 1),
3) applying a sealant composition, which is different from the solventborne composition used in step 1), at least in portion onto the optionally dried and/or cured film obtained after step 1) or 2) to form a sealant film,
wherein the sealant composition is obtained by mixing at least two separately present components A) and B) of a sealing system with each other, wherein component A) of the sealing system comprises at least one polymeric constituent A1) containing two or more thiol groups, which is selected from the group consisting of polyether, polythioether, polysulfide, polythioether-sulfide constituents and mixtures thereof, and wherein component B) of the sealing system comprises at least one constituent B0), which is suitable for curing the sealant composition by at least partially inducing a chemical transformation of the two or more thiol groups of constituent A1), and
4) optionally curing the sealant film obtained after step 3),
wherein the solventborne composition applied in step 1) comprises at least constituents a1) to a3), which are different from one another:
at least two organic solvents as constituent a1) in an amount of at least 85.0 wt.-%, based on the total weight of the composition, wherein said at least two organic solvents are alcohols and different from one another, and wherein at least one of the at least two alcohols has precisely one OH-group and the at least one other alcohol has at least two or more OH-groups,
at least one organic metalate, as constituent a2), the metal of the metalate being selected from the group consisting of Ti and Zr, and
at least one organosilane as constituent a3) in an amount of at most 10.0 wt.-%, based on the total weight of the composition,
wherein the sum of all constituents being present in the solventborne composition adds up to 100 wt.-%.

2. The method according to claim 1, wherein the solventborne composition used in step 1) comprises the at least two organic solvents as constituent a1) in an amount in a range of from 85.0 wt.-% to 99.0 wt.-%.

3. The method according to claim 1, wherein the at least two organic solvents as constituent a1) each have 3 to 10 or 4 to 7 carbon atoms.

4. The method according to claim 1, wherein the amount of the at least one alcohol having precisely one OH-group in wt.-% exceeds the amount of the at least one other alcohol having at least two OH-groups in wt.-%.

5. The method according to claim 1, wherein the solventborne composition used in step 1) comprises constituent a2) in an amount in a range of from 0.1 wt.-% to 15.0 wt.-%, based on the total weight of the composition.

6. The method according to claim 1, wherein the solventborne composition used in step 1) comprises constituent a3) in an amount in a range of from 0.1 wt.-% to 10.0 wt.-%, based on the total weight of the composition.

7. The method according to claim 1, wherein the solventborne composition used in step 1) further comprises
at least one colorant as constituent a4),
and/or at least one additive selected from the group consisting of reactive diluents, resins, polymeric resins, and mixtures thereof as constituent a5), in an amount in a range of from 0 or 0.01 to 7.5 wt.-%, based on the total weight of the composition.

8. The method according to claim 1, wherein the solventborne composition used in step 1) comprises:
the at least two organic solvents as constituent a1) in an amount in a range of from 87.5 wt.-% to 99.0 wt.-%, based on the total weight of the composition,
constituent a2) in an amount in a range of from 0.50 wt.-% to 7.50 wt.-%, based on the total weight of the composition,
constituent a3) in an amount in a range of from 0.50 wt.-% to 7.50 wt.-%, based on the total weight of the composition, and
optionally, at least one colorant as constituent a4) in an amount in a range of from 0 or 0.01 to 1.5 wt.-%.

9. The method according to claim 1, wherein the solventborne composition is applied in step 1) such that a dry layer thickness below 1.0 μm results.

10. The method according to claim 1, wherein component B) of the sealing system used for preparing the sealant composition used in step 3) comprises at least one constituent B0), which is selected from the group consisting of constituents comprising two or more epoxide groups (constituents B1)), constituents, which are metal oxides and/or metal peroxides (constituents B2)), constituents, which are organic peroxides (constituents B3)), constituents comprising two or more vinyl groups (constituents B4)), and mixtures thereof.

11. The method according to claim 1, wherein the optionally pre-coated substrate is selected from the group consisting of metal substrates, steel, steel alloys, aluminum, aluminum alloys, titanium, titanium alloys, and mixtures thereof, or is selected from the group consisting of glass substrates, thermoplastic substrates, polycarbonate substrates, polyalkyl(meth)acrylic substrates, and fiber reinforced composite substrates, wherein the substrate in each case optionally bears at least one coating layer.

12. A sealed substrate, obtained by the method according to claim 1.

13. A method of using the solventborne composition as defined in claim 1, the method comprising using the solventborne composition as an adhesion promoting composition.

14. A solventborne composition as defined in claim 1.

15. A kit-of-parts comprising separated from one another at least as defined in claim 1,
a sealing system comprising two components A) and B) being separate from each other, and
a solventborne composition.

16. The method according to claim 1, wherein the solventborne composition used in step 1) comprises the at least two organic solvents as constituent a1) in an amount in a range of from 85.0 wt.-% to 98.5 wt.-%.

17. The method according claim 1, wherein the relative weight ratio of the at least one alcohol having precisely one OH-group to the at least one alcohol having two or more OH-groups is in a range of from 5:1 to 3:1.

18. The method according claim 1, wherein the least two alcohols are present in the solventborne composition, when the optionally coated substrate used in step 1) is a metal substrate.

19. The method according to claim 1, wherein the solventborne composition used in step 1) comprises constituent a2) in an amount in a range of from 0.25 wt.-% to 12.0 wt.-%, based on the total weight of the composition.

20. The method according to claim 1, wherein the solventborne composition used in step 1) comprises constituent a3) in an amount in a range of from 0.25 wt.-% to 8.0 wt.-%, based on the total weight of the composition.
